(19) United States
(12) Patent Application Publication
(10) Pub. No.: US 2014/0168693 A1
(43) Pub. Date: Jun. 19, 2014

(54) PRINTING APPARATUS AND CONTROL METHOD THEREOF, IMAGE PROCESSING APPARATUS, IMAGE PROCESSING METHOD, AND NON-TRANSITORY COMPUTER-READABLE MEDIUM

(71) Applicant: CANON KABUSHIKI KAISHA, Tokyo (JP)

(72) Inventor: Naohiro Yamamoto, Machida-shi (JP)

(73) Assignee: CANON KABUSHIKI KAISHA, Tokyo (JP)

(21) Appl. No.: 14/080,047

(22) Filed: Nov. 14, 2013

(30) Foreign Application Priority Data
Dec. 17, 2012 (JP) 2012-275104

(51) Int. Cl. G06K 15/02

(52) U.S. Cl. CPC G06K 15/1894
USPC 358/1.15

(57) ABSTRACT

In a printing apparatus, an image processing unit comprises: a unit that decides a transfer speed of the signal of the image data to a print processing unit; a selection unit that selects, out of a plurality of thinning patterns, a thinning pattern to be applied to the image data; and a unit that performs thinning processing of the image data using the selected thinning pattern and transfers the signal of the image data that has undergone the thinning processing to the print processing unit at the decided transfer speed, wherein the selection unit selects the thinning pattern that does not superimpose a frequency component corresponding to a periodicity of a signal of the thinning pattern on a multiplying of the frequency component of the transfer speed of the signal of the decided image data.

### BACKGROUND OF THE INVENTION

1. Field of the Invention

The present invention relates to a printing apparatus and a control method thereof, an image processing apparatus, an image processing method, and a non-transitory computer-readable medium.

2. Description of the Related Art

A printing apparatus using electrophotography normally performs image processing of print target data (to be referred to as print data hereinafter) input from a personal computer (to be referred to as a PC hereinafter) or the like and converts it into raster data. After that, the converted raster data is transmitted to an optical output unit such as a semiconductor laser provided in the printing apparatus. The optical output unit develops a desired image on a printing medium such as a paper sheet by an electrophotographic process in accordance with the signal of the received image data, thereby obtaining a printed product.

The transfer speed of the electrical signal to transmit the raster data to the optical output unit of the semiconductor laser changes depending on the print speed of the printing apparatus. The electrical signal to be transmitted is formed from a digital signal (“1” and “0”) in accordance with the contents of the raster data after the image processing of the print data. For this reason, an electrical change (switching between “1” and “0”) of the digital signal occurs in accordance with the contents of the raster data, and noise is radiated from the electrical signal transmitted to the optical output unit along with the electrical change.

The radiant noise has a noise value that is a current value corresponding to each frequency. When the noise value is large, electrical signals other than the signal that is generating the radiant noise may be affected by the noise and take wrong signal values. For example, an electrical signal that should be determined as “1” changes its potential to the lower side of the potential range where the signal is determined as “1” due to the influence of radiant noise. In this case, the electrical signal is determined as the digital signal “0” and causes an operation error. To prevent the operation error of the electrical signal, unwanted radiant noise needs to be suppressed.

Japanese Patent Laid-Open No. 9-85993 discloses detecting the edge portions and non-edge portions of an image and correcting the non-edge portions to a lower density without correcting the density of the edge portions.

In the technique of Japanese Patent Laid-Open No. 9-85993, high-frequency raster image data in which white and black dots of the resolution of the printing apparatus are repeated may occur depending on the density to be reduced in density reduction processing. Additionally, in black density reduction processing using a PWM triangular wave, when raster image data in which dots less than the resolution continue is obtained by the PSM adjustment method, the white/black cycle period may becomes shorter than the period of the resolution.

In print processing of cyclic data having periodicity in print data, the current value (energy) of radiant noise increases in general. The transfer speed of the electrical signal to be transmitted is decided in accordance with the processing resolution and processing speed of the printing apparatus. When a frequency component that is a multiplying of the transfer speed of the electrical signal to be transmitted and the frequency component of the data of the electrical signal to be transmitted overlap, the overlapping frequency components resonate, and the energy of the radiant noise of the frequency components increases.

As a result, generally, the larger the energy of radiant noise by an image signal is, the larger the noise externally radiated from the printing apparatus is.

The present invention suppresses radiant noise that occurs due to an electrical signal by performing density reduction processing according to the print speed.

### SUMMARY OF THE INVENTION

According to one aspect of the present invention, there is provided a printing apparatus including an image processing unit and a print processing unit configured to perform print processing using a signal of image data transferred from the image processing unit, the image processing unit comprising: a holding unit configured to hold a plurality of thinning patterns; a decision unit configured to decide a transfer speed of the signal of the image data to the print processing unit in accordance with a speed of the print processing of the print processing unit; a selection unit configured to select, out of the plurality of thinning patterns, a thinning pattern to be applied to the image data; a processing unit configured to perform thinning processing of the image data using the thinning pattern selected by the selection unit; and a transfer unit configured to transfer the signal of the image data that has undergone the thinning processing of the processing unit to the print processing unit at the transfer speed decided by the decision unit, wherein the selection unit selects, out of the plurality of thinning patterns, the thinning pattern that does not superimpose a frequency component corresponding to a periodicity of a signal of the thinning pattern on a multiplying of the frequency component of the transfer speed of the signal of the image data decided by the decision unit.

According to another aspect of the present invention, there is provided a control method of a printing apparatus including an image processing unit and a print processing unit configured to perform print processing using a signal of image data transferred from the image processing unit, the method comprising: in the image processing unit, a holding step of holding a plurality of thinning patterns; a decision step of deciding a transfer speed of the signal of the image data to the print processing unit in accordance with a speed of the print processing of the print processing unit; a selection step of selecting, out of the plurality of thinning patterns, a thinning pattern to be applied to the image data; a processing step of performing thinning processing of the image data using the thinning pattern selected in the selection step; and a transfer step of transferring the signal of the image data that has undergone the thinning processing in the processing step to the print processing unit at the transfer speed decided in the decision step, wherein in the selection step, the thinning pattern that does not superimpose a frequency component corresponding to a periodicity of a signal of the thinning pattern on a multiplying of the frequency component of the transfer speed of the signal of the image data decided in the decision step is selected out of the plurality of thinning patterns.

According to another aspect of the present invention, there is provided a non-transitory computer-readable medium storing a program that causes a computer to function as: a holding unit configured to hold a plurality of thinning patterns; a decision unit configured to decide a transfer speed of a signal of image data to a print processing unit in accordance with a speed of print processing of the print processing unit; a selection unit configured to select, out of the plurality of thinning patterns, a thinning pattern to be applied to the image data; a processing unit configured to perform thinning processing of the image data using the thinning pattern selected by the selection unit; and a transfer unit configured to transfer the signal of the image data that has undergone the thinning processing of the processing unit to the print processing unit at the transfer speed decided by the decision unit, wherein the selection unit selects, out of the plurality of thinning patterns, the thinning pattern that does not superimpose a frequency component corresponding to a periodicity of a signal of the thinning pattern on a multiplying of the frequency component of the transfer speed of the signal of the image data decided by the decision unit.

According to another aspect of the present invention, there is provided an image processing apparatus comprising: a selection unit configured to select a thinning pattern to be applied to image data in accordance with a print speed of the image data; and a processing unit configured to perform thinning processing of the image data using the thinning pattern selected by the selection unit, wherein the selection unit selects the thinning pattern in which a frequency corresponding to a periodicity of the thinning pattern is not a multiplying of the frequency of a transfer clock to a print processing unit, which is decided by the print speed.

According to another aspect of the present invention, there is provided an image processing method comprising: a selection step of selecting a thinning pattern to be applied to image data in accordance with a print speed of the image data; and a processing step of performing thinning processing of the image data using the thinning pattern selected in the selection step, wherein in the selection step, the thinning pattern in which a frequency corresponding to a periodicity of the thinning pattern is not a multiplying of the frequency of a transfer clock to a print processing unit, which is decided by the print speed, is selected.

According to the present invention, it is possible to suppress the peak of electrical radiant noise that occurs due to the electrical signal of image data in accordance with print data and the processing speed of a printing apparatus.

Further features of the present invention will become apparent from the following description of exemplary embodiments (with reference to the attached drawings).

### BRIEF DESCRIPTION OF THE DRAWINGS

FIG. 1 is a block diagram of a printing apparatus according to the first embodiment;

FIG. 2 is a view showing an example of a thinning pattern according to the first embodiment;

FIG. 3 is a view for explaining the relationship between a printed image and the electrical signal of image data according to the first embodiment;

FIG. 4 is a flowchart showing processing of the thinning pattern according to the first embodiment;

FIG. 5 is a view showing an example of a user interface to select the thinning pattern according to the first embodiment;

FIG. 6 is a flowchart showing thinning pattern decision processing according to the first embodiment;

FIG. 7 is a block diagram showing the arrangement of a correction signal generation unit according to the first embodiment;

FIG. 8 is a view showing an example of a thinning pattern to be selected according to the first embodiment; and

FIG. 9 is a view showing an example of a user interface in an example of a printing apparatus according to the second embodiment.

### DESCRIPTION OF THE EMBODIMENTS

### First Embodiment

### Arrangement of Apparatus

A mode for carrying out the present invention will now be described with reference to the accompanying drawings.

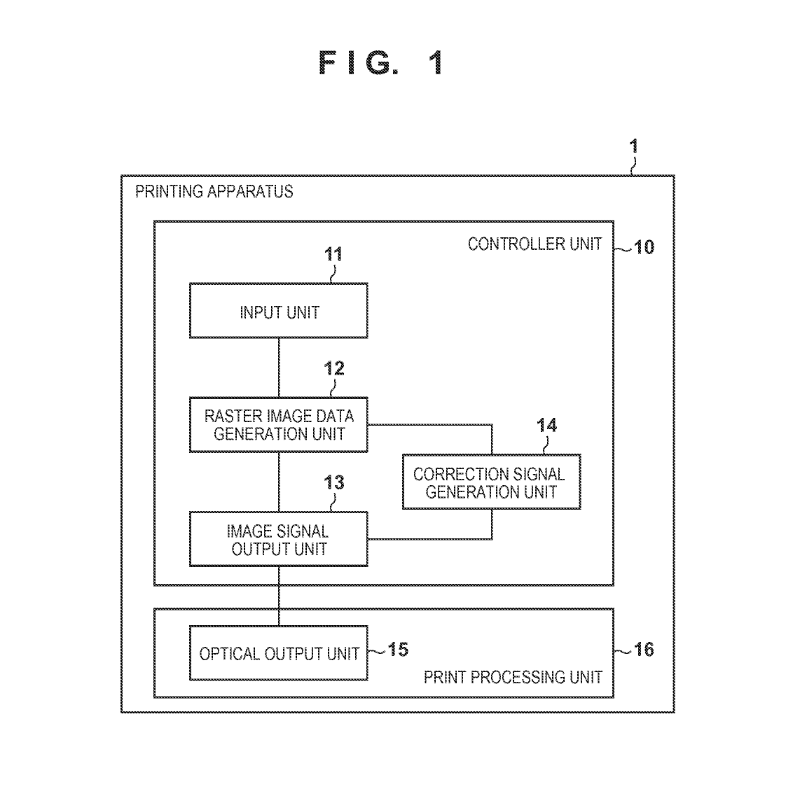

FIG. 1 is a block diagram of a printing apparatus 1 according to the first embodiment of the present invention. A controller unit 10 is an image processing unit (image processing apparatus) that performs various kinds of processing for input image data. The controller unit 10 receives a print instruction (print job) from a PC or the like, converts image data for printing into raster image data, and outputs it to a print processing unit 16. The controller unit 10 executes general control of these operations by a CPU (not shown).

Note that although the print instruction of the printing apparatus 1 is assumed to be an input from the PC or the like, print processing may start in accordance with input of image data read by various kinds of image reading apparatuses. A multi function peripheral including a printing apparatus and an image reading apparatus added to it may be used. An input unit 11 accepts the print instruction from the PC or the like and outputs print data to a raster image data generation unit 12. The input I/F of the print data can be either a network such as a LAN (Local Area Network) or a USB (Universal Serial Bus). That is, any method known in this technical field is usable as long as print data can be input.

The raster image data generation unit 12 generates raster image data based on the print data input via the input unit 11. The raster image data generation unit 12 outputs the image data to an image signal output unit 13 and a correction signal generation unit 14. The image signal output unit 13 combines the image data output from the raster image data generation unit 12 with a thinning pattern in accordance with a correction signal based on the thinning pattern output from the correction signal generation unit 14. The image signal output unit 13 outputs the combined image data to the print processing unit 16 as an image signal. The transfer speed of the image signal here will be described later.

The correction signal generation unit 14 confirms the presence of a black region that is a high density region surrounded by edges in the image data generated by the raster image data generation unit 12, and judges whether density correction is necessary for the black region. For example, density correction is performed not for the edge portions of the black region but for the entire region surrounded by the edges. Alternatively, density correction processing using a thinning pattern is performed for a partial region. If density correction is necessary, the correction signal generation unit 14 generates a correction signal and outputs it to the image signal output unit 13. In this embodiment, the processing is performed for the black region. However, the present invention is not limited to this, and a region (for example, a region formed from a color other than black) to be printed at a high density can also undergo the processing.

The print processing unit 16 forms an image based on the image signal output from the image signal output unit 13, and outputs a printed product. The print processing unit 16 includes an optical output unit 15. The optical output unit 15 is formed from a semiconductor laser (not shown) or the like. The optical output unit 15 converts the image signal output from the image signal output unit 13 into an optical output, and forms a raster image on a photosensitive drum (not shown) of the print processing unit 16.

The operation of the printing apparatus 1 according to this embodiment will be described below. The raster image data generation unit 12 performs raster processing of print data corresponding to a print instruction input from the input unit 11. The raster image data generation unit 12 also sends print mode information to the correction signal generation unit 14. The print mode information is sent to the print processing unit 16 as well. The print mode information will be described later.

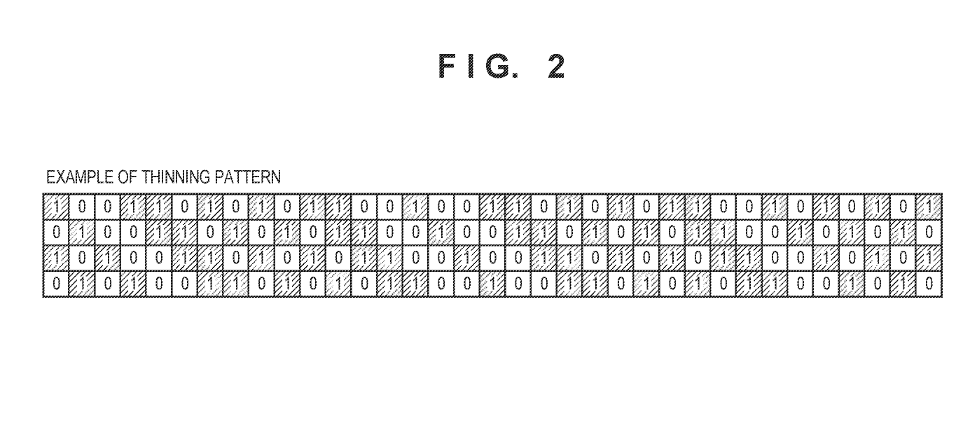

The correction signal generation unit 14 holds a plurality of types of thinning patterns including specific image regions, which are selected in accordance with print mode information. A thinning pattern is formed from, for example, a pattern as shown in FIG. 2. Pixel data of a specific pattern sequence are arranged in a window having a specific region. The correction signal generation unit 14 prepares a plurality of types of thinning patterns, and switches the thinning pattern in accordance with the print mode information of image data. The data of the selected thinning pattern is output to the image signal output unit 13.

The image signal output unit 13 transfers a VSYNC signal, an HSYNC signal, and a VCLK signal to the print processing unit 16. The VSYNC signal is the synchronizing signal in the sub-scanning direction of a printing medium (paper sheet) for the image data to be output to the print processing unit 16. The HSYNC signal is the synchronizing signal of a main scanning line in the main scanning direction of a sheet page. The VCLK signal indicates a transfer clock to transfer the image data to the print processing unit 16. The print processing unit 16 transfers an REQ signal representing a print request to the image signal output unit 13.

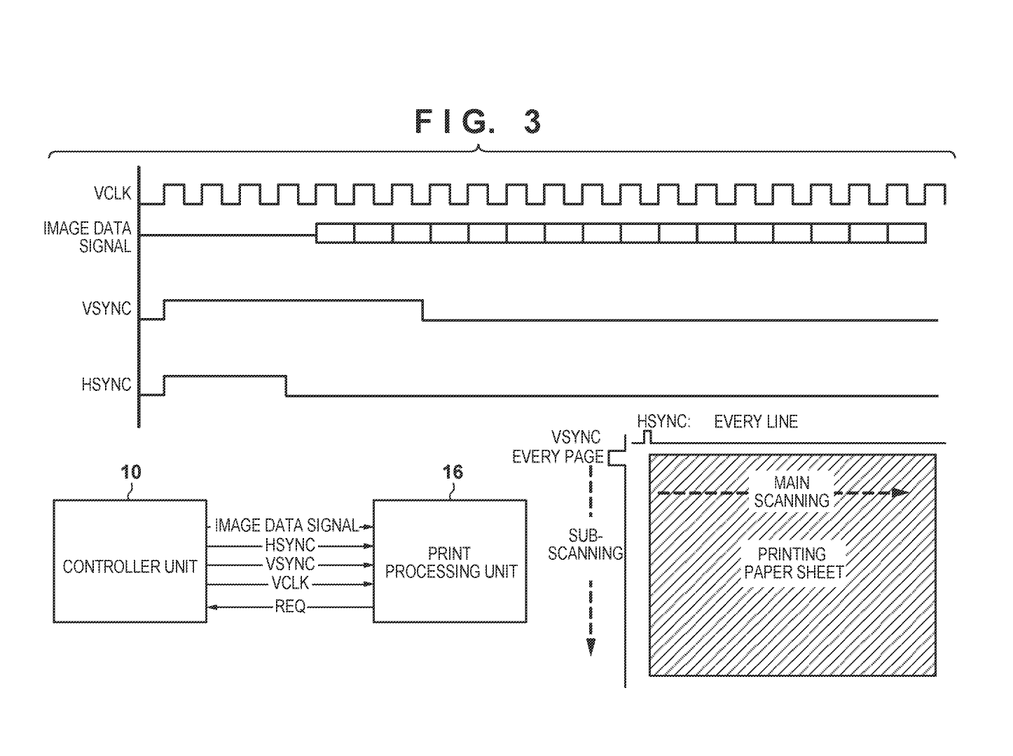

FIG. 3 shows the relationship of the above-described signals. The REQ signal represents the transfer request of image data to be printed. The REQ signal changes to active (for example, “1”) for each printing paper sheet to be printed. When the REQ signal is active, the image signal output unit 13 transfers the image data for print processing in synchronism with the VSYNC signal and the HSYNC signal. The print processing unit 16 can discriminate the transfer timing of the image data for each main scanning line of the image data based on the HSYNC signal that is the synchronizing signal for the main scanning line. The print processing unit 16 can discriminate the transfer timing of the image data for each paper sheet in the sub scanning direction of the image data based on the VSYNC signal that is the synchronizing signal for the sub-scanning line.

(Processing Procedure)

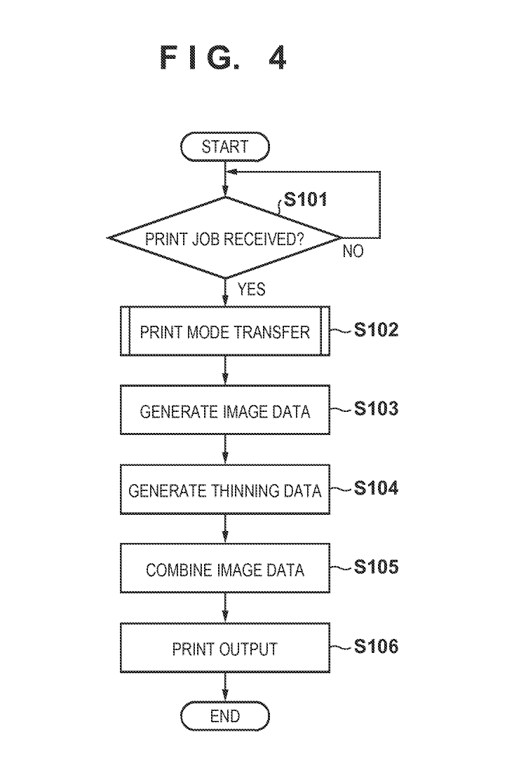

An image data output operation according to the print mode of image data in the printing apparatus 1 according to this embodiment will be described next with reference to the flowchart of FIG. 4. This processing procedure is implemented by the CPU and electrical circuits in the controller unit 10 of the printing apparatus 1.

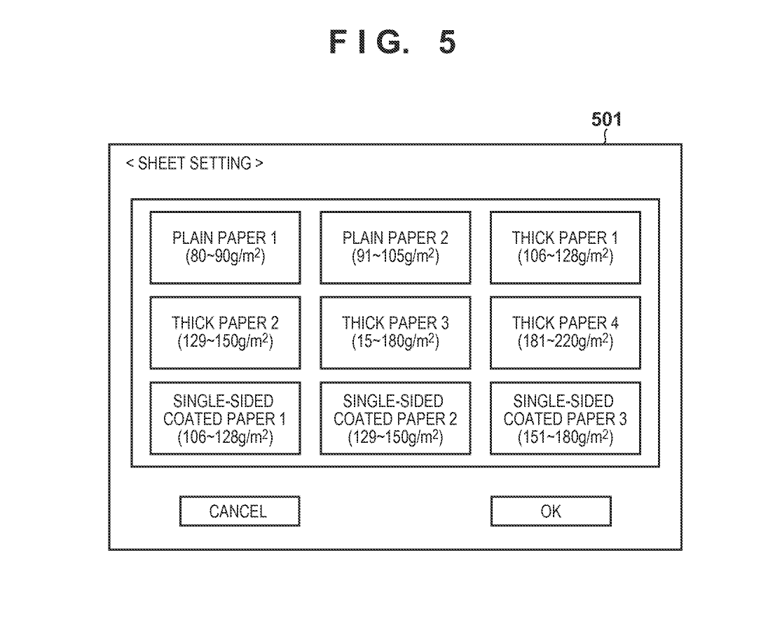

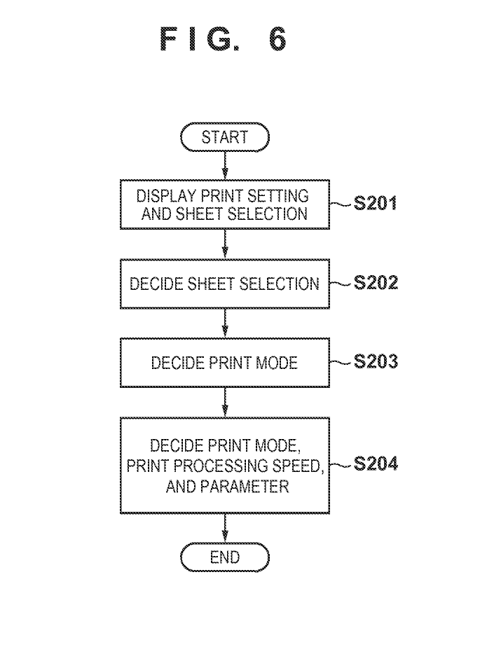

The printing apparatus 1 receives a print job via the input unit 11 (step S101). At this time, if the print mode is selected from a user interface (to be referred to as a UI hereinafter) provided to the user by the input unit 11, the printing apparatus 1 transfers the print mode to the correction signal generation unit 14 via the raster image data generation unit 12 (step S102). When no print mode is selected, the printing apparatus 1 designates the setting information of a predetermined print mode in the correction signal generation unit 14. Note that details of print mode selection processing will be described later with reference to FIGS. 5 and 6.

Next, the printing apparatus 1 causes the raster image data generation unit 12 to perform image processing in accordance with the contents of the print job and generate raster image data (step S103). The printing apparatus 1 causes the correction signal generation unit 14 to decide the thinning pattern (step S104). The printing apparatus 1 transmits the thinning pattern to the image signal output unit 13 such that the output timing of the print image data from the raster image data generation unit 12 synchronizes with the output timing of the thinning pattern data from the correction signal generation unit 14. The printing apparatus 1 causes the image signal output unit 13 to combine the image data and the thinning pattern data and transfer the combined data to the print processing unit 16 (step S105). At this time, since the print processing speed of the print processing unit 16 is decided by the parameter value of the print mode, the printing apparatus 1 causes the image signal output unit 13 to transfer the image data in accordance with the print speed.

The printing apparatus 1 causes the optical output unit 15 in the print processing unit 16 to convert the image data transmitted from the image signal output unit 13 into an optical output. After that, the printing apparatus 1 forms a raster image on the photosensitive drum (not shown), transfers the raster image onto a printing medium, and outputs it as a printed product (step S106).

(Mode Selection)

FIG. 5 shows an example of print mode selection by the input unit 11 of the printing apparatus 1. The print mode selection shown in FIG. 5 indicates an example in which a paper sheet to be printed is selected from display on a UI 501 provided by the input unit 11 of the printing apparatus 1. FIG. 6 illustrates the procedure of print mode selection processing.

The input unit 11 displays the UI 501 for the user when performing printing (step S201). The input unit 11 accepts selection of a paper type from the user via the UI 501 (step S202). In this embodiment, the printing paper sheet can be selected from paper sheets categorized into plain paper, coated paper, and thick paper. The input unit 11 switches the print mode in accordance with the selected printing paper sheet (step S203).

The print processing unit 16 associates a parameter indicating the processing speed of print processing with the print mode. For example, if “plain paper” is selected as the printing paper sheet, the processing speed of print processing is set to 60 ppm. When the user changes the printing paper sheet setting from “plain paper” to “thick paper”, the input unit 11 changes the parameter value of the processing speed of the print mode to 28 ppm. After paper type selection is completed, the input unit 11 decides the parameter value of the print mode (step S204).

The input unit 11 switches the print mode in accordance with the printing paper sheet, thereby changing the processing speed of print processing. The print processing unit 16 includes not only the optical output unit 15 but also a polygon mirror, a photosensitive drum, a charger, a fixing unit, a roller belt, and a heater (none are shown) for print processing of the printing paper sheet. The polygon mirror receives the optical output from the optical output unit 15 and irradiates the photosensitive drum with it while rotating at a uniform angular velocity. The photosensitive drum is charged by the charger, and develops the latent image formed on it by a toner. After that, the toner on the photosensitive drum is transferred to the printing paper sheet.

The printing apparatus 1 melts the toner transferred to the printing paper sheet by heat and a pressure obtained by combining the roller belt and the heat source of the heater and fixes the toner to the printing paper sheet. The time for fixing changes depending on the type of the printing paper sheet. Hence, the speed of the series of print processes needs to be changed. Depending on the type, the fixing time needs to be longer for, for example, thick paper than for plain paper. Hence, the timing of the optical output from the optical output unit 15 to irradiate the polygon mirror is delayed. For this reason, the transfer speed of the image data from the image signal output unit 13 to the optical output unit 15 needs to be decreased.

That is, the frequency of the transfer clock VCLK of the image data from the image signal output unit 13 to the print processing unit 16 is lowered.

(Correction Signal Generation Unit)

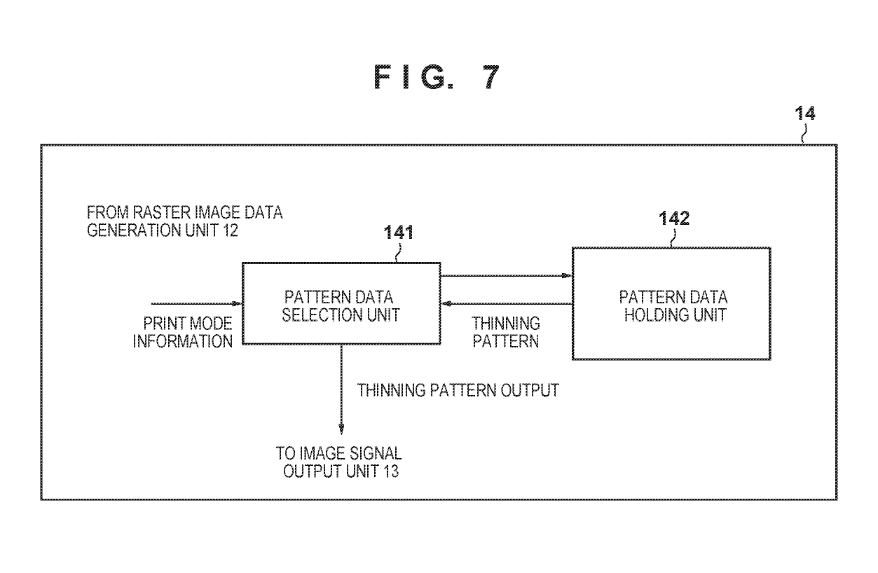

FIG. 7 shows the arrangement of the correction signal generation unit 14. The correction signal generation unit 14 includes a pattern data selection unit 141 and a pattern data holding unit 142. The pattern data holding unit 142 holds the data of thinning patterns according to the frequency components of the transfer clock of the image data with respect to the processing speed of print processing by the print processing unit 16. The thinning pattern is formed from a pattern sequence to reduce radiant noise.

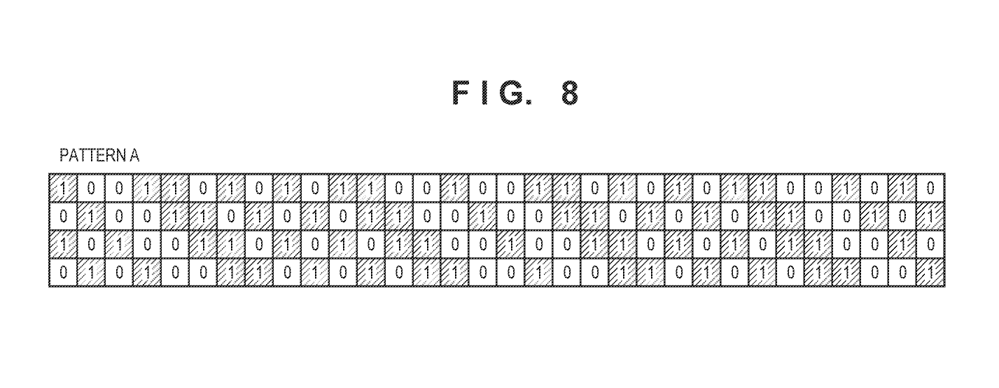

For example, when plain paper is selected as the printing paper sheet, and the processing speed of print processing is 60 ppm, the transfer clock VCLK is decided as 62 MHz. In this case, a pattern A shown in FIG. 8 is used as the thinning pattern. The pattern A shown in FIG. 8 is the pattern of a frequency that is not a multiplying of the transfer clock VCLK (62 MHz). When thick paper is selected as the printing paper sheet, and the processing speed of print processing is 28 ppm, the transfer clock VCLK is decided as 30 MHz. In this case as well, the pattern A shown in FIG. 8 is used as the thinning pattern. That is, the thinning pattern is selected such that the frequency component corresponding to the periodicity of the signal of the thinning pattern is not superimposed on the multiplying of the frequency of the transfer clock.

The pattern A in FIG. 8 is a pattern sequence having a periodicity of 14 pixels, and has a periodicity corresponding to 1/14 the transfer clock VCLK. For this reason, the pattern A is the pattern sequence of a frequency component that is different from the frequency of a multiplying of the transfer clock VCLK of 62 MHz. The thinning pattern data changes depending on the frequency of the transfer clock VCLK, as indicated by the pattern A of FIG. 8, and has a frequency component that cancels the peak of noise generated from the frequency component of the transfer clock VCLK. In this embodiment, all thinning patterns have the same thinning amount.

The pattern data selection unit 141 receives print mode information, and selects thinning pattern data stored in the pattern data holding unit 142 in accordance with the print mode. The pattern data selection unit 141 then outputs the selected thinning pattern data to the image signal output unit 13.

The thinning pattern data is repetitively output in accordance with the print target region of the printing paper sheet and reflected on the whole or partial region of the print target region. For example, thinning processing may be performed not for the edge portions of a high density region but only for several lines inside the edges.

(Processing of Image Signal Output Unit)

Processing of the image signal output unit 13 will be explained next. The image signal output unit 13 combines the image data generated by the raster image data generation unit 12 with the thinning pattern data output from the correction signal generation unit 14. The image signal output unit 13 combines the data such that the start position of the image represented by the raster image data becomes the same as the start position of the thinning pattern data. The image signal output unit 13 transmits the combined image data to the print processing unit 16 in synchronism with the transfer clock VCLK.

The peak of radiant noise generated from an electrical signal line from image data dependent of the transfer clock VCLK is suppressed by the image data thinned using the thinning pattern.

As described above, peak of radiant noise according to this embodiment is reduced. This obviates the necessity of using a noise filter for the electrical signal from the image signal output unit 13 or a noise shielding metal plate in the electrical signal path, unlike the related art.

### Second Embodiment

In the first embodiment, printing paper sheet selection is received from the user via the UI 501 displayed on the input unit 11 of the printing apparatus 1, and the print processing speed is switched in accordance with the setting. The printing apparatus 1 selects an appropriate one of a plurality of thinning patterns prepared in the correction signal generation unit 14 in accordance with the print processing speed, and applies it to image data.

In the second embodiment, two print modes, a quiet mode that suppresses a print sound made at the time of print processing and a normal print mode that performs normal print processing are provided. In the quiet mode, the operation speeds of the photosensitive drum, roller belt, fixing units, and the like in a print processing unit 16 are reduced to suppress the operation sound made at the time of printing. This can suppress the operation sound from each device in the print processing unit 16.

Concerning the second embodiment of the present invention, only the difference from the first embodiment will be described below.

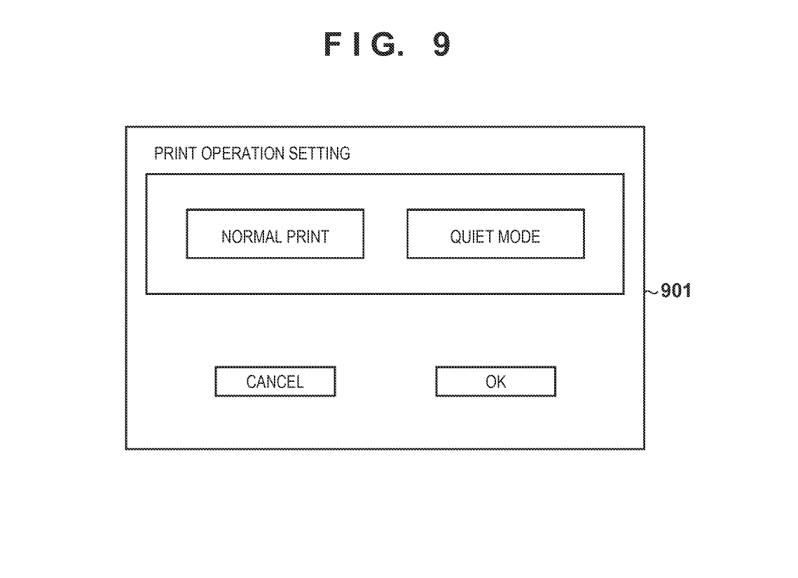

FIG. 9 shows a print mode setting screen on a UI 901 displayed on an input unit 11 of a printing apparatus 1.

When the quiet mode is selected, the printing apparatus 1 lowers the frequency of a transfer clock VCLK of image data from an image signal output unit 13 to the print processing unit 16. For example, when the print mode is the normal print mode, the print processing speed is 100 ppm. On the other hand, in the quiet mode, the print processing speed is 60 ppm.

A correction signal generation unit 14 prepares a plurality of thinning patterns in accordance with the function of the print processing speed of the connected print processing unit 16. As a thinning pattern for the normal print mode, a noise reduction pattern for the print processing speed of 100 ppm is prepared. As the thinning pattern of the correction signal generation unit 14 when the print mode is the quiet mode, a noise reduction thinning pattern for the print processing speed of 60 ppm is prepared.

The thinning pattern is switched in accordance with the specifications of the processing mode of the printing apparatus 1 as the print mode is switched, thereby easily performing noise reduction processing.

Note that the thinning patterns held by the correction signal generation unit 14 may be patterns uniquely be decided for each specification of the print processing unit 16 in advance. A plurality of thinning patterns may be prepared and selected in correspondence with the combination of settings. When a plurality of print processing units having different specifications are provided, the thinning patterns may be held in accordance with the specifications of the print processing units.

As another embodiment, the present invention is also applicable to a printing apparatus that includes a detection unit (sensor) configured to detect a temperature or humidity and switches the print processing speed in accordance with the detected temperature or humidity. In this case, the printing apparatus switches the thinning pattern in accordance with the print processing speed according to a change in the temperature or humidity.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-275104, filed Dec. 17, 2012, which is hereby incorporated by reference herein in its entirety.

What is claimed is:

1. A printing apparatus including an image processing unit and a print processing unit configured to perform print processing using a signal of image data transferred from said image processing unit,
said image processing unit comprising:
a holding unit configured to hold a plurality of thinning patterns;
a decision unit configured to decide a transfer speed of the signal of the image data to said print processing unit in accordance with a speed of the print processing of said print processing unit;
a selection unit configured to select, out of the plurality of thinning patterns, a thinning pattern to be applied to the image data;
a processing unit configured to perform thinning processing of the image data using the thinning pattern selected by said selection unit; and
a transfer unit configured to transfer the signal of the image data that has undergone the thinning processing of said processing unit to said print processing unit at the transfer speed decided by said decision unit,
wherein said selection unit selects, out of the plurality of thinning patterns, the thinning pattern that does not superimpose a frequency component corresponding to a periodicity of a signal of the thinning pattern on a multiplying of the frequency component of the transfer speed of the signal of the image data decided by said decision unit.

2. The apparatus according to claim 1, further comprising a unit configured to accept a setting of the print processing of said print processing unit,
wherein said print processing unit switches the speed of the print processing in correspondence with the setting of the print processing, and
said decision unit decides the transfer speed of the image data in correspondence with the speed of the print processing.

3. The apparatus according to claim 2, wherein the setting of the print processing is the setting of one of a paper type and a print mode.

4. The apparatus according to claim 1, further comprising a detection unit configured to detect a change in one of a temperature and humidity,
wherein said print processing unit switches the speed of the print processing in accordance with the detected change in one of the temperature and humidity, and
said decision unit decides the transfer speed of the image data in correspondence with the speed of the print processing.

5. The apparatus according to claim 1, wherein all of the plurality of thinning patterns have the same thinning amount.

6. A control method of a printing apparatus including an image processing unit and a print processing unit configured to perform print processing using a signal of image data transferred from the image processing unit, the method comprising:
in the image processing unit,
a holding step of holding a plurality of thinning patterns;
a decision step of deciding a transfer speed of the signal of the image data to the print processing unit in accordance with a speed of the print processing of the print processing unit;
a selection step of selecting, out of the plurality of thinning patterns, a thinning pattern to be applied to the image data;
a processing step of performing thinning processing of the image data using the thinning pattern selected in the selection step; and
a transfer step of transferring the signal of the image data that has undergone the thinning processing in the processing step to the print processing unit at the transfer speed decided in the decision step,
wherein in the selection step, the thinning pattern that does not superimpose a frequency component corresponding to a periodicity of a signal of the thinning pattern on a multiplying of the frequency component of the transfer speed of the signal of the image data decided in the decision step is selected out of the plurality of thinning patterns.

7. A non-transitory computer-readable medium storing a program that causes a computer to function as:
a holding unit configured to hold a plurality of thinning patterns;
a decision unit configured to decide a transfer speed of a signal of image data to a print processing unit in accordance with a speed of print processing of said print processing unit;
a selection unit configured to select, out of the plurality of thinning patterns, a thinning pattern to be applied to the image data;
a processing unit configured to perform thinning processing of the image data using the thinning pattern selected by said selection unit; and
a transfer unit configured to transfer the signal of the image data that has undergone the thinning processing of said processing unit to said print processing unit at the transfer speed decided by said decision unit,
wherein said selection unit selects, out of the plurality of thinning patterns, the thinning pattern that does not superimpose a frequency component corresponding to a periodicity of a signal of the thinning pattern on a multiplying of the frequency component of the transfer speed of the signal of the image data decided by said decision unit.

8. An image processing apparatus comprising:
a selection unit configured to select a thinning pattern to be applied to image data in accordance with a print speed of the image data; and
a processing unit configured to perform thinning processing of the image data using the thinning pattern selected by said selection unit,
wherein said selection unit selects the thinning pattern in which a frequency corresponding to a periodicity of the thinning pattern is not a multiplying of the frequency of a transfer clock to a print processing unit, which is decided by the print speed.

9. An image processing method comprising:
a selection step of selecting a thinning pattern to be applied to image data in accordance with a print speed of the image data; and
a processing step of performing thinning processing of the image data using the thinning pattern selected in the selection step,
wherein in the selection step, the thinning pattern in which a frequency corresponding to a periodicity of the thinning pattern is not a multiplying of the frequency of a transfer clock to a print processing unit, which is decided by the print speed, is selected.

10. A non-transitory computer-readable medium storing a program that causes a computer to function as an image processing apparatus described in claim 8.
